(19) United States
(12) Patent Application Publication
(10) Pub. No.: US 2008/0182135 A1
(43) Pub. Date: Jul. 31, 2008

(54) MAGNETIC RECORDING MEDIUM

(75) Inventors: Yuichiro MURAYAMA, Odawara-shi (JP); Hiroshi HASHIMOTO, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/019,734

(22) Filed: Jan. 25, 2008

(30) Foreign Application Priority Data
Jan. 25, 2007 (JP) 2007-014924

(51) Int. Cl. G11B 5/733; G11B 5/70; G11B 5/738

(52) U.S. Cl. 428/840.2; 428/840; 428/840.1

(57) ABSTRACT

A magnetic recording medium is provided that comprises a non-magnetic support and, in order thereabove, a radiation-cured layer cured by exposing a layer comprising a radiation curing compound to radiation, and a magnetic layer comprising a ferromagnetic powder dispersed in a binder, the radiation-cured layer comprising an inorganic powder that has been surface treated with a silane coupling agent.

### BACKGROUND OF THE INVENTION

1. Field of the Invention

The present invention relates to a magnetic recording medium such as a magnetic tape or a magnetic disk, and to a magnetic recording medium comprising, above a non-magnetic support, at least one magnetic layer formed by dispersing a ferromagnetic powder and a binder.

2. Description of the Related Art

As tape-form magnetic recording media for audio, video, and computers, and disc-form magnetic recording media such as flexible discs, a magnetic recording medium has been used in which a magnetic layer having dispersed in a binder a ferromagnetic powder such as y-iron oxide, Co-containing iron oxide, chromium oxide, or a ferromagnetic metal powder is provided on a support. With regard to the support used in the magnetic recording medium, polyethylene terephthalate (PET), polyethylene naphthalate (PEN), etc. are generally used. Since these supports are drawn and are highly crystallized, their mechanical strength is high and their solvent resistance is excellent.

The magnetic layer, which is obtained by coating the support with a coating solution having the ferromagnetic powder dispersed in the binder, has a high degree of packing of the ferromagnetic powder, low elongation at break, and is brittle, and it is therefore easily destroyed by the application of mechanical force and might peel off from the support. In order to prevent this, an undercoat layer is provided on the support so as to make the magnetic layer adhere strongly to the support.

On the other hand, magnetic recording media are known in which a radiation-cured layer is formed using a compound having a functional group that is cured by radiation such as an electron beam, that is, a radiation curing compound (ref. JP-A-S60-133531, JP-A-S57-40747, and JP-A-2001-84582; JP-A denotes a Japanese unexamined patent application publication). Furthermore, a magnetic recording medium provided with a radiation-cured layer formed using a compound having a cyclic structure has been proposed (ref. JP-A-2003-132522).

Furthermore, it has been proposed that by adding an inorganic filler to a radiation-cured layer the smoothness of a magnetic layer is improved, or the coating strength is improved (ref. JP-A-2004-5890, JP-A-2004-272941, JP-A-2004-303328, and JP-A-1-213829). However, the radiation-cured layers disclosed in these patent publications have the problem that sufficient Electromagnetic conversion characteristics, smoothness, and strength cannot be obtained.

### BRIEF SUMMARY OF THE INVENTION

It is an object of the present invention to provide a magnetic recording medium having excellent coating smoothness, electromagnetic conversion characteristics, transport durability, and storage stability.

The problems to be solved by the present invention are solved by means described in (1) below. This is described below together with (2) to (12), which are preferred embodiments.

(1) A magnetic recording medium comprising a non-magnetic support and, in order thereabove, a radiation-cured layer cured by exposing a layer comprising a radiation curing compound to radiation, and a magnetic layer comprising a ferromagnetic powder dispersed in a binder, the radiation-cured layer comprising an inorganic powder that has been surface treated with a silane coupling agent,

(2) the magnetic recording medium according to (1), wherein the silane coupling agent is represented by formula (1),

X₄₋ₙ—Si—(Y)ₙ (1)

here, X denotes an alkyl group having 4 to 18 carbons, a phenyl group, a (meth)acryloxy group, or a (meth)acryloxyalkyl group having an alkyl group having 1 to 18 carbons, Y denotes OCH₃, OC₂H₅, or OC₃H₇, and n is 2 or 3,

(3) the magnetic recording medium according to (1), wherein the silane coupling agent is at least one compound selected from the group consisting of hexyltrimethoxysilane, decyltrimethoxysilane, stearyltrimethoxysilane, phenyltrimethoxysilane, acryloxytrimethoxysilane, hexyltriethoxysilane, and hexyltripropoxysilane,

(4) the magnetic recording medium according to (1), wherein the inorganic powder that has been surface treated with a silane coupling agent is an organic solvent-dispersed silica sol,

(5) the magnetic recording medium according to (1), wherein the content in the radiation-cured layer of the inorganic powder that has been surface treated with a silane coupling agent is at least 30 vol % but no greater than 60 vol %,

(6) the magnetic recording medium according to (1), wherein the inorganic powder that has been surface treated with a silane coupling agent has an average particle size of at least 5 nm but no greater than 50 nm,

(7) the magnetic recording medium according to (1), wherein the magnetic recording medium comprises, between the radiation-cured layer and the magnetic layer, a non-magnetic layer comprising a non-magnetic powder dispersed in a binder,

(8) the magnetic recording medium according to (1), wherein the radiation curing compound is an ethylenically unsaturated compound,

(9) the magnetic recording medium according to (1), wherein the radiation curing compound is a polyfunctional (meth)acrylate compound,

(10) the magnetic recording medium according to (1), wherein the radiation curing compound is at least one compound selected from the group consisting of tricyclodecanedimethanol diacrylate, hexanediol diacrylate, and trimethylolpropane triacrylate,

(11) the magnetic recording medium according to (1), wherein it has a coefficient of thermal expansion of no greater than 14.0 ppm/° C., and

(12) the magnetic recording medium according to (1), wherein the non-magnetic support is a non-magnetic support selected from the group consisting of polyethylene terephthalate, polyethylene naphthalate, and polyamide.

### DETAILED DESCRIPTION OF THE INVENTION

The present invention is explained in detail below.

The magnetic recording medium of the present invention comprises a non-magnetic support and, in order thereabove, a radiation-cured layer cured by exposing a layer comprising a radiation curing compound to radiation; and a magnetic layer comprising a ferromagnetic powder dispersed in a binder, the radiation-cured layer comprising an inorganic powder that has been surface treated with a silane coupling agent.

Furthermore, it preferably comprises, between the radiation-cured layer and the magnetic layer, a non-magnetic layer comprising a non-magnetic powder dispersed in a binder.

The magnetic recording medium of the present invention comprises, above a non-magnetic support, a radiation-cured layer formed by exposing a radiation curing compound to radiation.

Since the radiation curing compound is generally a monomer or an oligomer, which have a low molecular weight, and it is easy to level a low viscosity coating, excellent smoothness can be obtained. However, such a radiation-cured layer has a large thermal expansion, and in particular in a magnetic recording medium for computer use transport errors, etc. might occur due to a change in dimensions under the environment used for storage. Furthermore, the radiation-cured layer might come off from the tape edge due to repetitive sliding, and this might cause transport failure.

The magnetic recording medium of the present invention comprises an inorganic powder in the radiation-cured layer, and has an effect in suppressing the above-mentioned thermal expansion. On the other hand, when an inorganic powder such as silica is contained as in a conventional technique, since the smoothness is degraded due to aggregation of particles and sufficient smoothness cannot be obtained, only a small amount of inorganic powder can be contained. In accordance with the present invention, there is an effect in suppressing the aggregation of particles by surface treating the inorganic powder with a silane coupling agent, and also in suppressing a change in dimensions of the magnetic recording medium due to a change in temperature while maintaining high smoothness. Furthermore, it is possible for a relatively large amount of inorganic powder to be contained compared with the conventional technique, the mechanical strength of the radiation-cured layer can be improved, and there is also an effect in suppressing loss of the radiation-cured layer due to repetitive sliding.

### I. Radiation-Cured Layer

In the present invention, the radiation-cured layer is a layer formed by curing a radiation curing compound-containing layer by exposure to radiation, and comprises an inorganic powder that has been surface treated with a silane coupling agent.

### 1. Radiation Curing Compound

In the present invention, a ‘radiation curing compound’ contained in the radiation-cured layer is a compound having the property of polymerizing or crosslinking when it is exposed to radiation such as ultraviolet rays or an electron beam and curing to become a macromolecule. The radiation curing compound does not react unless it is exposed to external energy (ultraviolet rays or an electron beam). Because of this, a coating solution containing the radiation curing compound has a stable viscosity unless it is irradiated with ultraviolet rays or an electron beam, and a high coating smoothness can be obtained. Furthermore, since the reaction proceeds instantaneously by virtue of the high energy of ultraviolet rays or an electron beam, the coating solution containing the radiation curing compound can give a high coating strength.

Examples of the radiation used in the present invention include various types of radiation such as an electron beam (β rays), ultraviolet rays, X rays, γ rays, and α rays.

As the radiation curing compound, an ethylenically unsaturated compound is preferable, and examples thereof include a (meth)acrylate compound ((meth)acrylic acid ester) obtained by reacting with a polyhydric alcohol a carboxylic acid, represented by acrylic acid or methacrylic acid, and a compound having a radiation curing functional group, and a urethane(meth)acrylate obtained by reacting with a polyhydric alcohol a compound having a radiation curing functional group and a group that reacts with a hydroxyl group, represented by 2-isocyanatoethyl acrylate or 2-isocyanatoethyl methacrylate.

There are also those obtained by reacting a diisocyanate compound or an isocyanate terminal prepolymer with a compound having a radiation curing functional group and a group that reacts with an isocyanate group, represented by hydroxyethyl(meth)acrylate or hydroxybutyl(meth)acrylate. ‘(Meth)acrylate’ has the meaning of both acrylate and methacrylate.

As the polyhydric alcohol, in addition to diols used as conventionally known polyurethane starting materials, polyester polyols, polyether polyols, polycarbonate polyols, polyolefin polyols, and polyether ester polyols may be used. As the diisocyanate compound, a known starting material for a polyurethane may be used.

Examples of tri- or higher-functional polyfunctional(meth)acrylates include trimethylolpropane tri(meth)acrylate, trimethylolethane tri(meth)acrylate, ditrimethylolpropane tetra(meth)acrylate, glycerol tri(meth)acrylate, pentaerythritol tri(meth)acrylate, pentaerythritol tetra(meth)acrylate, dipentaerythritol penta(meth)acrylate, dipentaerythritol hexa(meth)acrylate, and ethylene oxide- or propylene oxide-modified products thereof.

Examples of difunctional compounds include 1,3-butanediol di(meth)acrylate, 1,4-butanediol di(meth)acrylate, 1,6-hexanediol di(meth)acrylate, diethylene glycol di(meth)acrylate, polyethylene glycol di(meth)acrylate, neopentyl glycol di(meth)acrylate, and cyclopentadienyl alcohol di(meth)acrylate.

Among them, a preferred radiation curing compound is a di-functional monomer, and a more preferred di-functional monomer is a radiation curing compound having an acryloyl group or a methacryloyl group. And as a functional group an acryloyl group is preferred to a methacryloyl group since the polymerizability is excellent.

Furthermore, as the structure of the radiation curing compound, from the viewpoint of the balance between mechanical strength and hygroscopicity of the magnetic recording medium obtained being excellent, an aliphatic or alicyclic diacrylate is preferable.

Preferred examples of the aliphatic diacrylate include hexamethylenediol diacrylate(hexanediol diacrylate), 2-ethyl-2-butyl-1,3-propanediol diacrylate, 3-methylpentanediol diacrylate, 2-methyloctanediol diacrylate, nonanediol diacrylate, neopentylglycol hydroxypivalate diacrylate, and a urethane diacrylate of trimethylhexamethylene diisocyanate.

Preferred examples of the alicyclic diacrylate include cyclohexanedimethanol diacrylate, limonene alcohol diacrylate, tricyclodecanedimethanol diacrylate, dimer diol diacrylate, 5-ethyl-2-(2-hydroxy-1,1′-dimethylethyl)-5-(hydroxymethyl)-1,3-dioxane diacrylate, tetrahydrofurandimethanol diacrylate, and 3,9-bis(1,1-dimethyl-2-hydroxyethyl)-2,4,8,10-tetraoxaspiro[5.5]undecane diacrylate. Among them, tricyclodecanedimethanol diacrylate is preferable.

Examples of (meth)acrylates other than the above polyfunctional esters include epoxy (meth)acrylates, polysiloxane poly(meth)acrylates, and polyamide poly(meth)acrylates. There are polyether(meth)acrylate, urethane(meth)acrylate, etc. and, although it is not particularly limited thereto, urethane (meth)acrylate is preferable.

In the present invention, the radiation-cured layer may employ a known radiation curing monomer such as a (meth)acrylate compound described in ‘Teienerugi Denshisenshosha no Oyogijutsu’ (Application of Low-energy Electron Beam) (Published by CMC), ‘UV•EB Kokagijutsu’ (UV/EB Radiation Curing Technology) (published by the Sogo Gijutsu Center), etc.

As the radiation curing compound used, one having two or more acryloyl groups is preferable.

Other than the above, it is also possible to use one having four or more acryloyl groups, such as dipentaerythritol tetraacrylate, dipentaerythritol pentaacrylate, dipentaerythritol hexaacrylate, or ditrimethylolpropane tetraacrylate, but it is preferable to use it in combination with a difunctional and/or trifunctional (meth)acrylate. It is preferable for the radiation curing compound to be di- or tri-functional since the storage stability of starting materials is good. Good curability can also be obtained, which is preferable.

Furthermore, for reasons of adjusting viscosity, improving adhesion to a substrate, etc., a monofunctional (meth)acrylate may be added as necessary. Examples of such a monofunctional (meth)acrylate include 2-hydroxyethyl(meth)acrylate, 2-hydroxypropyl(meth)acrylate, 3-hydroxybutyl(meth)acrylate, 4-hydroxybutyl(meth)acrylate, 2-hydroxypentyl(meth)acrylate, 4-hydroxypentyl(meth)acrylate, 2-ethylhexyl(meth)acrylate, ethoxyethyl(meth)acrylate, N-hydroxymethyl(meth)acrylamide, and N-methoxymethyl(meth)acrylamide. The amount of these monofunctional (meth)acrylates used is preferably at least 0 wt % but no greater than 40 wt % of the entire radiation curing compound, and more preferably at least 0 wt % but no greater than 30 wt % when taking into consideration scratch resistance, etc.

The radiation curing compound used in the present invention preferably has a molecular weight of 200 to 1,000. It is preferable for the molecular weight to be at least 200 since unreacted material does not precipitate on the surface of a coated film. Furthermore, It is preferable for the molecular weight to be no greater than 1,000 since the viscosity is appropriate and sufficient smoothness can be obtained.

The viscosity at 25° C. of the radiation curing compound of the present invention is preferably 100 to 10,000 mPa·s, more preferably 300 to 7,000 mPa·s, and yet more preferably 500 to 2,000 mPa·s.

It is preferable for the viscosity of the radiation curing compound to be in the above-mentioned range since excellent smoothness of the magnetic recording medium can be obtained.

The radiation-cured layer preferably does not contain a binder, and it is preferable that substantially only the radiation curing compound is cured. However, this does not exclude the radiation-cured layer from comprising an additive such as an inorganic powder that has been surface treated with a silane coupling agent, which will be described later, another inorganic powder, a polymerization initiator, or a pigment.

### 2. Inorganic Powder

The magnetic recording medium of the present invention comprises a radiation-cured layer comprising an inorganic powder that has been surface treated with a silane coupling agent.

The inorganic powder here is not particularly limited; a known inorganic powder can be appropriately selected and used, and it may be selected from, for example, inorganic compounds such as a metal oxide, a metal carbonate, a metal sulfate, a metal nitride, a metal carbide, and a metal sulfide.

Specific examples thereof include α-alumina having an alpha component proportion of 90% or greater, β-alumina, γ-alumina, θ-alumina, silicon dioxide, silicon carbide, chromium oxide, cerium oxide, α-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide, and they may be used singly or in combination. Particularly preferred inorganic powders are silicon dioxide, α-iron oxide, and titanium dioxide.

With regard to an inorganic powder that is to be subjected to a surface treatment with a silane coupling agent, from the viewpoint of particle size, a narrow particle size distribution, variety of means for imparting function, etc., silicon dioxide is particularly preferable, and a colloidal silica dispersed in an organic solvent is more preferable. Furthermore, as an inorganic powder, a colloidal silica that is synthesized by a sol-gel method using an alkoxysilane as a starting material and dispersed in an organic solvent may be used suitably.

Examples of the organic solvent include cyclohexanone, MEK (methyl ethyl ketone), toluene, isopropyl alcohol, MIBK (methyl isobutyl ketone), methanol, and ethanol. Among them, the organic solvent for dispersing the inorganic powder is preferably an alcoholic solvent, and more preferably methanol or ethanol. It is preferable to use an alcoholic solvent since the dispersion stability is good.

The inorganic powder that has been surface treated with a silane coupling agent (also called a ‘treated inorganic powder’, the same applies below) preferably has an average particle size of at least 5 nm but no greater than 50 nm, more preferably at least 10 nm but no greater than 30 nm, and yet more preferably at least 15 nm but no greater than 20 nm. It is preferable for the average particle size of the inorganic powder that has been surface treated with a silane coupling agent (treated inorganic powder) to be in the above-mentioned range since a magnetic recording medium having excellent smoothness can be obtained.

The shape of the inorganic powder that is to be subjected to surface treatment with a silane coupling agent is not particularly limited, and an acicular, ellipsoidal, spherical, laminar, etc. form may be used. Moreover, it is preferable to appropriately select the average particle size of the inorganic powder so that the average particle size of the treated inorganic powder falls in the above-mentioned range. Since there is hardly any change in the particle size of the inorganic powder as a result of the surface treatment with a silane coupling agent, the average particle size of the treated inorganic powder can be considered to be approximately the same as the particle size of the inorganic powder prior to the surface treatment.

The particle size of the treated inorganic powder referred to here means primary particle size. The average particle size referred to here means volume-average particle size on a cumulative basis.

Examples of methods for measuring the particle size of the treated inorganic powder include a laser light scattering particle size distribution analyzer and a particle size distribution analyzer employing an ultrasonic attenuation method.

Furthermore, with regard to a method for measuring the average particle size of the treated inorganic powder in the magnetic recording medium, after a cross section of the magnetic recording medium is cut using FIB (focused ion beam), the radiation-cured layer is examined by SEM at 50,000 times, and the average particle size of the treated inorganic powder in the radiation-cured layer may be calculated using image analysis software. The cumulative volume-average particle size of the treated inorganic powder may be determined by considering it to be spherical.

### 3. Silane Coupling Agent for Surface Treatment of Inorganic Powder

In the magnetic recording medium of the present invention, the radiation-cured layer comprises an inorganic powder that has been surface treated with a silane coupling agent.

In the present invention, the silane coupling agent carries out a surface treatment by reacting with active hydrogen atoms (e.g. OH) of the surface of the inorganic powder.

The silane coupling agent that can be used is not particularly limited. Examples thereof include methyltrimethoxysilane, dimethyldimethoxysilane, trimethylmethoxysilane, methyltriethoxysilane, dimethyldiethoxysilane, hexyltrimethoxysilane, hexyltriethoxysilane, hexyltripropoxysilane, decyltrimethoxysilane, dodecyltrimethoxysilane, myristyltrimethoxysilane, octyltrimethoxysilane, stearyltrimethoxysilane, phenyltrimethoxysilane, benzyltrimethoxysilane, propyltrimethoxysilane, aminopropyltrimethoxysilane, vinyltrimethoxysilane, vinyltriethoxysilane, styryltrimethoxysilane, glycidoxypropyltrimethoxysilane, acryloxytrimethoxysilane, acryloxypropyltrimethoxysilane, methacryloxypropyltrimethoxysilane, aminopropyltrimethoxysilane, mercaptopropyltrimethoxysilane, isocyanatopropyltrimethoxysilane, ureidopropyltrimethoxysilane, and isocyanatopropyltrimethoxysilane.

Among them, a trimethoxysilane type is preferable due to ease of dehydration-condensation during the surface treatment process.

Hexyltrimethoxysilane, decyltrimethoxysilane, and phenyltrimethoxysilane are particularly preferable.

In the present invention, the silane coupling agent is preferably a compound represented by formula (1) below.

X₄₋ₙ—Si—(Y)ₙ (1)

Here, X denotes an alkyl group having 4 to 18 carbons, a phenyl group, a (meth)acryloxy group, or a (meth)acryloxyalkyl group having an alkyl group having 1 to 18 carbons, Y denotes OCH₃, OC₂H₅, or OC₃H₇, and n is 2 or 3.

Specific examples thereof include hexyltrimethoxysilane, hexyltriethoxysilane, hexyltripropoxysilane, decyltrimethoxysilane, dodecyltrimethoxysilane, myristyltrimethoxysilane, octyltrimethoxysilane, stearyltrimethoxysilane, phenyltrimethoxysilane, benzyltrimethoxysilane, propyltrimethoxysilane, aminopropyltrimethoxysilane, acryloxypropyltri methoxysilane, and methacryloxypropyltri methoxysilane.

From the viewpoint of ease of dehydration-condensation during the surface treatment process, Y is preferably OCH₃. Furthermore, n is preferably 3. As particularly preferable silane coupling agents, hexyltrimethoxysilane, decyltrimethoxysilane, and phenyltrimethoxysilane can be cited.

The surface treatment of the inorganic powder with a silane coupling agent is preferably carried out in solution. It is preferable to carry out the treatment by mixing a solution in which a silane coupling agent has been dissolved and an inorganic powder or a solution containing an inorganic powder (preferably a dispersion of an inorganic powder), and dispersing it while stirring using an ultrasonic device, a stirrer, a homogenizer, a dissolver, a planetary mixer, a paint shaker, a sand grinder, a kneader, etc.

As a solvent used for dissolving the silane coupling agent, an organic solvent having high polarity is preferable. Specific examples thereof include known solvents such as alcohols, ketones, and esters, and an alcohol or a ketone is preferable. They may be used singly, or a plurality of organic solvents may be used as a mixture.

The silane coupling agent is preferably added at at least 10 parts by weight but no greater than 40 parts by weight relative to 100 parts by weight of the inorganic powder, and more preferably at least 15 parts by weight but no greater than 30 parts by weight. It is preferable for the amount of silane coupling agent added to be within the above-mentioned range since the surface treatment is carried out well.

As a method for treating silicon dioxide particles with a silane coupling agent, a method disclosed in JP-A-2005-314197 may be cited as an example. A specific example thereof includes a treatment method comprising (a) a first step in which the hydrophilic organic solvent of a high purity hydrophilic organic solvent-dispersed silica sol derived from an alkoxysilane is replaced with an amphiphilic organic solvent having a boiling point of at least 100° C., (b) a second step in which the silica sol obtained in the first step is subjected to a surface treatment with a silane coupling agent, and (c) a third step in which the amphiphilic organic solvent having a boiling point of at least 100° C. of the silica sol obtained in the second step is replaced with a hydrophobic organic solvent. Furthermore, it is preferable in the second step to carry out the surface treatment of the silica sol with a silane coupling agent under acidic conditions.

The high purity hydrophilic organic solvent-dispersed silica sol may be a hydrophilic organic solvent-dispersed silica sol produced by any conventionally known process using an alkoxysilane as a starting material. As a process for producing a high purity hydrophilic organic solvent-dispersed silica sol, it may be obtained by hydrolyzing a hydrolyzable silicon compound, for example, an alkoxysilane such as tetramethyl silicate, tetraethyl silicate, tetraisopropyl silicate, tetrabutyl silicate, or dimethyldiethyl silicate or a chlorosilane such as tetrachlorosilane in a hydrophilic organic solvent such as methanol, ethanol, or isopropanol (sol-gel method). It may also be obtained by solvent replacement of water, which is a dispersion medium for a water-dispersed silica sol, with a hydrophilic organic solvent by a known method, for example, by using an ultrafilter.

The hydrophilic organic solvent is not particularly limited, and examples thereof include straight-chain or branched alcohols having 1 to 3 carbons such as methanol, ethanol, n-propanol, and isopropanol.

Examples of the amphiphilic organic solvent having a boiling point of at least 100° C. include monohydric alcohols having at least 4 carbons such as n-butanol, s-butanol, n-pentanol, and n-hexanol, dihydric alcohols such as ethylene glycol, propylene glycol, diethylene glycol, and triethylene glycol, polyhydric alcohols such as glycerol, high molecular weight alcohols such as polyethylene glycol and polyvinyl alcohol, ethylene glycol monoethyl ether, ethylene glycol monoethyl ether acetate, and propylene glycol monomethyl ether.

In the present invention, the amphiphilic organic solvent is particularly preferably an amphiphilic organic solvent having a boiling point of at least 100° C. but no greater than 200° C., and more preferably an amphiphilic organic solvent having a boiling point of at least 100° C. but no greater than 150° C.

The method for replacing the hydrophilic organic solvent of a high purity hydrophilic organic solvent-dispersed silica sol with an amphiphilic organic solvent having a boiling point of at least 100° C. is not particularly limited, and examples thereof include a method in which a fixed amount at a time of an amphiphilic organic solvent is added dropwise to the hydrophilic organic solvent-dispersed silica sol while heating it at a temperature around the boiling point of the hydrophilic organic solvent. In this process, the replacement procedure is preferably carried out until the liquid temperature and the column top temperature reach the boiling point of the solvent.

Examples thereof also include a method in which, after the hydrophilic organic solvent-dispersed silica sol is separated from the hydrophilic organic solvent by precipitation/separation, centrifugation, etc., it is redispersed in an amphiphilic organic solvent having a boiling point of at least 100° C.

The second step is a step in which the silica sol obtained in the first step is subjected to a surface treatment with a silane coupling agent. This surface treatment is preferably carried out under acidic conditions.

In order to subject the silica sol obtained in the first step to the surface treatment with a silane coupling agent, an acid is added to the silica sol obtained in the first step to adjust it so that it becomes acidic, the silane coupling agent is then added thereto, and the mixture is refluxed by heating or is heated at a temperature below the boiling point of the amphiphilic organic solvent, preferably at on the order of at least 50° C. but no greater than 200° C., thus carrying out the surface treatment.

It is preferable to add an acid since the surface treatment can be carried out reliably and quickly. It is preferable to carry out the surface treatment under acidic conditions since good viscosity is obtained and the solids concentration of the silica sol can be set high.

The acid is not particularly limited; examples thereof include an organic acid such as formic acid or acetic acid, an inorganic acid such as sulfuric acid or hydrochloric acid, and a strongly acidic ion-exchange resin, and the amount of acid added is not particularly limited but is preferably at least 1 wt % but no greater than 30 wt % of the silica sol. The pH region is not particularly limited, but it is desirably adjusted to a pH of no greater than 4. In the present invention, it is industrially preferable to use acetic acid.

The radiation-cured layer preferably comprises at least 30 vol % but no greater than 60 vol %, and more preferably at least 40 vol % but no greater than 50 vol %, of an inorganic powder that has been surface treated with a silane coupling agent.

‘The radiation-cured layer comprising at least 30 vol % but no greater than 60 vol % of an inorganic powder that has been surface treated with a silane coupling agent’ referred to here means that in the radiation-cured layer after curing, the inorganic powder that has been surface treated with a silane coupling agent is contained at at least 30 vol % but no greater than 60 vol %.

The radiation curing compound undergoes volume shrinkage (curing shrinkage) by a few % as a result of radiation curing, but the above-mentioned volume % (vol %) can be estimated from the volume excluding solvent, etc. from the radiation-cured layer prior to curing.

The content of the treated inorganic powder in the radiation-cured layer may be determined by cutting a cross section of the magnetic recording medium by means of FIB (focused ion beam) and then examining the radiation-cured layer by SEM at 50,000 times.

Furthermore, the inorganic powder that has been surface treated with a silane coupling agent (treated inorganic powder) is preferably an organic solvent-dispersed silica sol treated with a silane coupling agent. The organic solvent-dispersed silica sol referred to here is silicic anhydride (anhydrous silicon dioxide) dispersed in an organic solvent.

Examples of the organic solvent, which is a dispersion medium, include cyclohexanone, MEK, toluene, isopropyl alcohol, and MIBK, and among them cyclohexanone is preferable. It is preferable for the inorganic powder that has been surface treated with a silane coupling agent to be an organic solvent-dispersed silica sol since good dispersibility is obtained.

### 4. Exposure to Radiation

The radiation used in the present invention may be an electron beam or ultraviolet rays. When ultraviolet rays are used, it is necessary to add a photopolymerization initiator to the above-mentioned compound. In the case of curing with an electron beam, no polymerization initiator is required, and the electron beam has a deep penetration depth, which is preferable.

With regard to electron beam accelerators, there are a scanning system, a double scanning system, and a curtain beam system, and the curtain beam system is preferable since it is relatively inexpensive and gives a high output. With regard to electron beam characteristics, the acceleration voltage is preferably 30 kV to 1,000 kV, and more preferably 50 kV to 300 kV, and the absorbed dose is preferably 0.5 kV (5 kGy) to 20 Mrad (200 kGy), and more preferably 2 kV (20 kGy) to 10 Mrad (100 kGy). It is preferable for the acceleration voltage to be 30 kV or greater, since the amount of energy penetrating is sufficient, and it is preferable for it to be 1,000 kV or less since the energy efficiency is good and economical.

The electron beam irradiation atmosphere is preferably controlled by a nitrogen purge so that the concentration of oxygen is 200 ppm or less. It is preferable if the concentration of oxygen is 200 ppm or less, since crosslinking and curing reactions in the vicinity of the surface are not inhibited.

As a light source for the ultraviolet rays, a mercury lamp is preferable. The mercury lamp is a 20 to 240 W/cm lamp and is preferably used at a speed of 0.3 to 20 m/min. The distance between a substrate and the mercury lamp is generally preferably 1 to 30 cm.

As a photopolymerization initiator used for ultraviolet curing, a radical photopolymerization initiator is used. More particularly, those described in, for example, ‘Shinkobunshi Jikkengaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include aromatic ketones, such as acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone. The mixing ratio of the photopolymerization initiator is preferably 0.5 to 20 parts by weight relative to 100 parts by weight of the radiation curing compound, more preferably 2 to 15 parts by weight, and yet more preferably 3 to 10 parts by weight. It is preferable for the mixing ratio of the photopolymerization initiator to be in the above-mentioned range since good curability is obtained.

With regard to the radiation-curing equipment, conditions, etc., known equipment and conditions described in ‘UV•EB Kokagijutsu’ (UV/EB Radiation Curing Technology) (published by the Sogo Gijutsu Center), ‘Teienerugi Denshisenshosha no Oyogijutsu’ (Application of Low-energy Electron Beam) (2000, Published by CMC), etc. can be employed.

### 5. Carbon Black

It is preferable in the present invention to add carbon black to the radiation-cured layer.

Adding carbon black enables the surface electrical resistance Rs to be reduced, which is a known effect, the light transmittance to be reduced, and a desired micro Vickers hardness to be obtained. On the other hand, adding no carbon black at all is also a preferred embodiment.

The type of carbon black that can be used includes furnace black for rubber, thermal black for rubber, carbon black for coloring, acetylene black, etc. Carbon black in the radiation-cured layer should have properties such as those described below optimized depending on desired effects, and the combined use thereof might enhance the effects.

The specific surface area of the carbon black is preferably 100 to 500 m²/g, and more preferably 150 to 400 m²/g. The dibutylphthalate (DBP) oil absorption thereof is preferably 20 to 400 mL/100 g, and more preferably 30 to 200 mL/100 g. The average particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, MA-600, MA-230, #4000, and #4010 (manufactured by Mitsubishi Chemical Corporation), CONDUCTEX SC, RAVEN 8800, 8000, 7000, 5750, 5250, 3500, 2100, 2000, 1800, 1500, 1255, and 1250 (manufactured by Columbian Carbon Co.), Ketjen Black EC (manufactured by Akzo).

The carbon black may be surface treated using a dispersant or grafted with a resin, or part of the surface thereof may be converted into graphite. Prior to adding carbon black to a coating solution, the carbon black may be predispersed with a binder.

The carbon black is preferably used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the present invention can be selected by referring to, for example, the ‘Kabon Burakku Binran (Carbon Black Handbook) (edited by the Carbon Black Association of Japan).

### 6. Properties of Radiation-Cured Layer

### Thickness

The thickness of the radiation-cured layer in the present invention is preferably 0.1 to 1.0 μm. It is preferable if the thickness of the radiation-cured layer is no less than 0.1 μm since sufficient smoothness can be obtained, and it is preferable if it is no greater than 1.0 μm since the adhesion to a support is good.

### Glass Transition Temperature

The glass transition temperature (Tg) of the radiation-cured layer after curing is preferably 80° C. to 150° C., and more preferably 100° C. to 130° C. It is preferable if the glass transition temperature of the radiation-cured layer is no less than 80° C. since there are no problems with tackiness during a coating step, and it is preferable if it is no greater than 150° C. since the coating strength is desirable.

### Modulus of Elasticity

The modulus of elasticity of the radiation-cured layer after curing is preferably 1.5 to 10 GPa, and more preferably 2 to 10 GPa.

It is preferable if the modulus of elasticity is no less than 1.5 GPa since there are no problems with tackiness of a coating, and it is preferable if it is no greater than 10 GPa since the coating strength is desirable.

### Average Roughness

The average roughness (Ra) of the radiation-cured layer in the present invention is preferably 1 to 2 nm for a cutoff value of 0.25 nm.

It is preferable if the average roughness (Ra) of the radiation-cured layer is no less than 1 nm since there are few problems with sticking to a path roller during a coating step, and it is preferable if it is no greater than 2 nm since the magnetic layer has sufficient smoothness.

### II. Magnetic Layer

A magnetic recording medium of the present invention comprises a magnetic layer comprising a ferromagnetic powder dispersed in a binder above a non-magnetic support.

### 1. Ferromagnetic Powder

The magnetic recording medium of the present invention preferably employs as a ferromagnetic powder an acicular ferromagnetic substance having a major axis length of 20 to 50 nm, a tabular magnetic substance having a particle size of 10 to 50 nm, or a spherical or ellipsoidal magnetic substance having a diameter of 10 to 50 nm. Each thereof is explained below.

### (1) Acicular Ferromagnetic Substance

As the ferromagnetic powder used in the magnetic recording medium of the present invention, an acicular ferromagnetic substance having a major axis length of 20 to 50 nm may be used. Examples of the acicular ferromagnetic substance include an acicular ferromagnetic metal powder such as a cobalt-containing ferromagnetic iron oxide or a ferromagnetic alloy powder; the BET specific surface area (SBET) is preferably 40 to 80 m²/g, and more preferably 50 to 70 m²/g. The crystallite size is preferably 12 to 25 nm, more preferably 13 to 22 nm, and particularly preferably 14 to 20 nm. The major axis length is preferably 20 to 50 nm, and more preferably 20 to 40 nm.

Examples of the ferromagnetic metal powder include yttrium-containing Fe, Fe—Co, Fe—Ni, and Co—Ni—Fe, and the yttrium content in the ferromagnetic metal powder is preferably at least 0.5 atom % but no greater than 20 atom % as the yttrium atom/iron atom ratio Y/Fe, and more preferably at least 5 atom % but no greater than 10 atom %. It is preferable for the yttrium content is at least 5 atom % since the ferromagnetic metal powder has a high σs value, and good magnetic properties and electromagnetic conversion characteristics can be obtained. Furthermore, it is preferable for the yttrium content is no greater than 20 atom % since the iron content also becomes appropriate, it is possible to obtain good magnetic properties and electromagnetic conversion characteristics. Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

One example of a process for producing the ferromagnetic metal powder in the present invention, into which cobalt or yttrium has been introduced, is illustrated below.

For example, an iron oxyhydroxide obtained by blowing an oxidizing gas into an aqueous suspension in which a ferrous salt and an alkali have been mixed can be used as a starting material.

This iron oxyhydroxide is preferably of the α-FeOOH type, and with regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain an Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable.

In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

In the present invention, neodymium, samarium, praseodymium, lanthanum, gadolinium etc. can be introduced into the ferromagnetic metal powder of the present invention as well as yttrium. They can be introduced using a chloride such as neodymium chloride, samarium chloride, praseodymium chloride, or lanthanum chloride or a nitrate salt such as neodymium nitrate or gadolinium nitrate, and they can be used in a combination of two or more types.

The coercive force (Hc) of the ferromagnetic metal powder is preferably 159.2 to 238.8 kA/m (2,000 to 3,000 Oe), and more preferably 167.2 to 230.8 kA/m (2,100 to 2,900 Oe).

The saturation magnetic flux density is preferably 150 to 300 mT (1,500 to 3,000 G), and more preferably 160 to 290 mT (1,600 to 2,900 G). The saturation magnetization (σs) is preferably 100 to 170 A·m²/kg (100 to 170 emu/g), and more preferably 110 to 160 A·m²/kg (110 to 160 emu/g).

The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle size distribution of goethite, a technique of using monodispersed α-Fe₂O₃, and a technique of preventing sintering between particles, etc. in the ferromagnetic metal powder.

### (2) Tabular Magnetic Substance

The tabular magnetic substance having a particle size of 10 to 50 nm that can be used in the present invention is preferably a hexagonal ferrite powder.

Examples of the hexagonal ferrite include substitution products of barium ferrite, strontium ferrite, lead ferrite, and calcium ferrite, and Co substitution products. More specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. In addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr may be included. In general, those to which Co—Zn, Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is preferably 10 to 50 nm as a hexagonal plate size. When a magnetoresistive head is used for playback, the plate size is preferably equal to or less than 40 nm so as to reduce noise. It is preferable if the plate size is in such a range, since stable magnetization can be expected due to the absence of thermal fluctuations, and since noise is reduced it is suitable for high density magnetic recording.

The tabular ratio (plate size/plate thickness) is preferably 1 to 15, and more preferably 2 to 7. It is preferable if the tabular ratio is in such a range since adequate orientation can be obtained, and noise due to inter-particle stacking decreases. The SBET of a powder having a particle size within this range is usually 10 to 200 m²/g. The specific surface area substantially coincides with the value obtained by calculation using the plate size and the plate thickness. The crystallite size is preferably 5 to 45 nm, and more preferably 10 to 35 nm. The plate size and the plate thickness distributions are preferably as narrow as possible. Although it is difficult, the distribution can be expressed using a numerical value by randomly measuring 500 particles on a TEM photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the magnetic substance can be adjusted so as to be on the order of 39.8 to 398 kA/m (500 to 5,000 Oe). A higher Hc is advantageous for high-density recording, but it is restricted by the capacity of the recording head. It is usually on the order of 63.7 to 318.4 kA/m (800 to 4,000 Oe), but is preferably at least 119.4 kA/m (1,500 Oe) and at most 278.6 kA/m (3,500 Oe). When the saturation magnetization of the head exceeds 1.4 T, it is preferably 159.2 kA/m (2,000 Oe) or higher.

The Hc can be controlled by the particle size (plate size, plate thickness), the type and amount of element included, the element replacement sites, the conditions used for the particle formation reaction, etc. The saturation magnetization (σs) is 40 to 80 A·m²/kg (40 to 80 emu/g). A higher σs is preferable, but there is a tendency for it to become lower when the particles become finer. In order to improve the σs, making a composite of magnetoplumbite ferrite with spinel ferrite, selecting the types of element included and their amount, etc. are well known. It is also possible to use a W type hexagonal ferrite.

When dispersing the magnetic substance (magnetic powder), the surface of the magnetic substance can be treated with a material that is compatible with a dispersing medium and the polymer. With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance. The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the magnetic recording medium. The moisture contained in the magnetic substance also influences the dispersion. Although the optimum value depends on the dispersing medium and the polymer, it is usually selected from 0.01% to 2.0%.

With regard to a production method for the ferromagnetic hexagonal ferrite powder, there are: glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder;

hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; and co-precipitation method (3) in which a barium ferrite composition metal salt solution is neutralized with an alkali, and after a by-product is removed, it is dried and treated at 1,100° C. or less, and ground to give a barium ferrite crystal powder, etc., but a hexagonal ferrite used in the present invention may be produced by any method.

### (3) Spherical or Ellipsoidal Magnetic Substance

The spherical or ellipsoidal magnetic substance is preferably an iron nitride-based ferromagnetic powder containing Fe₁₆N₂ as a main phase. It may comprise, in addition to Fe and N atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, or Nb. The content of N relative to Fe is preferably 1.0 to 20.0 atom %.

The iron nitride is preferably spherical or ellipsoidal, and the major axis length/minor axis length axial ratio is preferably 1 to 2. The BET specific surface area (S_{BET}) is preferably 30 to 100 m²/g, and more preferably 50 to 70 m²/g. The crystallite size is preferably 12 to 25 nm, and more preferably 13 to 22 nm.

The saturation magnetization σs is preferably 50 to 200 A·m²/kg (emu/g), and more preferably 70 to 150 A·m²/kg (emu/g).

### 2. Binder

Examples of the binder used in the magnetic layer include a polyurethane resin, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl alkyral resin such as polyvinyl acetal or polyvinyl butyral, and they can be used singly or in a combination of two or more types. Among these, the polyurethane resin, the acrylic resin, the cellulose resin, and the vinyl chloride resin are preferable.

In order to improve the dispersibility of the ferromagnetic powder and the non-magnetic powder, the binder preferably has a functional group (polar group) that is adsorbed on the surface of the powders. Preferred examples of the functional group include —SO₃M, —SO₄M, —PO(OM)₂, —OPO(OM)₂, —COOM, >NSO₃M, >NRSO₃M, —NR¹R², and —N⁺R¹R²R³X—. M denotes a hydrogen atom or an alkali metal such as Na or K, R denotes an alkylene group, R¹, R², and R³ denote alkyl groups, hydroxyalkyl groups, or hydrogen atoms, and X denotes a halogen such as Cl or Br. The amount of functional group in the binder is preferably 10 to 200 μeq/g, and more preferably 30 to 120 μeq/g. It is preferable if it is in this range since good dispersibility can be achieved.

The binder preferably includes, in addition to the adsorbing functional group, a functional group having an active hydrogen, such as an —OH group, in order to improve the coating strength by reacting with an isocyanate curing agent so as to form a crosslinked structure. A preferred amount is 0.1 to 2 meq/g.

The molecular weight of the binder is preferably 10,000 to 200,000 as a weight-average molecular weight, and more preferably 20,000 to 100,000. It is preferable if the weight-average molecular weight is in this range since the coating strength is sufficient, the durability is good, and the dispersibility improves.

The polyurethane resin, which is a preferred binder, is described in detail in, for example, ‘Poriuretan Jushi Handobukku’ (Polyurethane Resin Handbook) (Ed., K. Iwata, 1986, The Nikkan Kogyo Shimbun, Ltd.), and it may normally be obtained by addition-polymerization of a long chain diol, a short chain diol (also known as a chain extending agent), and a diisocyanate compound. As the long chain diol, a polyester diol, a polyether diol, a polyetherester diol, a polycarbonate diol, a polyolefin diol, etc, having a molecular weight of 500 to 5,000 may be used. Depending on the type of this long chain polyol, the polyurethane is called a polyester urethane, a polyether urethane, a polyetherester urethane, a polycarbonate urethane, etc.

The polyester diol may be obtained by a condensation-polymerization between a glycol and a dibasic aliphatic acid such as adipic acid, sebacic acid, or azelaic acid, or a dibasic aromatic acid such as isophthalic acid, orthophthalic acid, terephthalic acid, or naphthalenedicarboxylic acid. Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol, 1,8-octanediol, 1,9-nonanediol, cyclohexanediol, cyclohexanedimethanol, and hydrogenated bisphenol A. As the polyester diol, in addition to the above, a polycaprolactonediol or a polyvalerolactonediol obtained by ring-opening polymerization of a lactone such as ε-caprolactone or γ-valerolactone can be used.

From the viewpoint of resistance to hydrolysis, the polyester diol is preferably one having a branched side chain or one obtained from an aromatic or alicyclic starting material.

Examples of the polyether diol include polyethylene glycol, polypropylene glycol, polytetramethylene glycol, aromatic glycols such as bisphenol A, bisphenol S, bisphenol P, and hydrogenated bisphenol A, and addition-polymerization products from an alicyclic diol and an alkylene oxide such as ethylene oxide or propylene oxide.

These long chain diols can be used as a mixture of a plurality of types thereof.

The short chain diol can be chosen from the compound group that is cited as the glycol component of the above-mentioned polyester diol. Furthermore, a small amount of a tri- or higher-hydric alcohol such as, for example, trimethylolethane, trimethylolpropane, or pentaerythritol can be added, and this gives a polyurethane resin having a branched structure, thus reducing the solution viscosity and increasing the number of OH end groups of the polyurethane so as to improve the curability with the isocyanate curing agent.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/diisocyanate ratio in the polyurethane resin is preferably (80 to 15 wt %)/(5 to 40 wt %)/(15 to 50 wt %).

The concentration of urethane groups in the polyurethane resin is preferably 1 to 5 meq/g, and more preferably 1.5 to 4.5 meq/g. It is preferable if the concentration of urethane groups is in the above range since the mechanical strength is high, the solution viscosity is low and the good dispersibility can be achieved.

The glass transition temperature of the polyurethane resin is preferably 0° C. to 200° C., and more preferably 40° C. to 160° C. It is preferable if it is in this range since the durability is excellent and the calender moldability is good and the excellent electromagnetic conversion characteristics can be obtained.

With regard to a method for introducing the adsorbing functional group (polar group) into the polyurethane resin, there are, for example, a method in which the functional group is used in a part of the long chain diol monomer, a method in which it is used in a part of the short chain diol, and a method in which, after the polyurethane is formed by polymerization, the polar group is introduced by a polymer reaction.

As the vinyl chloride resin, a copolymer of a vinyl chloride monomer and various types of monomer may be used.

Examples of the comonomer include fatty acid vinyl esters such as vinyl acetate and vinyl propionate, acrylates and methacrylates such as methyl(meth)acrylate, ethyl(meth)acrylate, isopropyl(meth)acrylate, butyl(meth)acrylate, and benzyl(meth)acrylate, alkyl allyl ethers such as allyl methyl ether, allyl ethyl ether, allyl propyl ether, and allyl butyl ether, and others such as styrene, α-methylstyrene, vinylidene chloride, acrylonitrile, ethylene, butadiene, and acrylamide; examples of a comonomer having a functional group include vinyl alcohol, 2-hydroxyethyl(meth)acrylate, polyethylene glycol(meth)acrylate, 2-hydroxypropyl(meth)acrylate, 3-hydroxypropyl(meth)acrylate, polypropylene glycol(meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glycidyl(meth)acrylate, allyl glycidyl ether, phosphoethyl(meth)acrylate, sulfoethyl(meth)acrylate, p-styrenesulfonic acid, and Na salts and K salts thereof.

The proportion of the vinyl chloride monomer in the vinyl chloride resin is preferably 60 to 95 wt %. It is preferable if it is in this range since the mechanical strength improves, the solvent solubility is high, and good dispersibility can be obtained due to desirable solution viscosity.

A preferred amount of a functional group for improving the curability of the adsorbing functional group (polar group) with a polyisocyanate curing agent is as described above. With regard to a method for introducing these functional groups, a monomer containing the above-mentioned functional group may be copolymerized, or after the vinyl chloride resin is formed by copolymerization, the functional group may be introduced by a polymer reaction.

A preferred degree of polymerization is 200 to 600, and more preferably 240 to 450. It is preferable if the degree of polymerization is in this range since the mechanical strength is high and good dispersibility can be obtained due to desirable solution viscosity.

In order to increase the mechanical strength and heat resistance of a coating by crosslinking and curing the binder used in the present invention, it is possible to use a curing agent. A preferred curing agent is a polyisocyanate compound. The polyisocyanate compound is preferably a tri- or higher-functional polyisocyanate.

Specific examples thereof include adduct type polyisocyanate compounds such as a compound in which 3 moles of TDI (tolylene diisocyanate) are added to 1 mole of trimethylolpropane (TMP), a compound in which 3 moles of HDI (hexamethylene diisocyanate) are added to 1 mole of TMP, a compound in which 3 moles of IPDI (isophorone diisocyanate) are added to 1 mole of TMP, and a compound in which 3 moles of XDI (xylylene diisocyanate) are added to 1 mole of TMP, a condensed isocyanurate type trimer of TDI, a condensed isocyanurate type pentamer of TDI, a condensed isocyanurate heptamer of TDI, mixtures thereof, an isocyanurate type condensation product of HDI, an isocyanurate type condensation product of IPDI, and crude MDI.

Among these, the compound in which 3 moles of TDI are added to 1 mole of TMP, and the isocyanurate type trimer of TDI are preferable.

Other than the isocyanate curing agents, a radiation curing agent that cures when exposed to an electron beam, ultraviolet rays, etc. may be used. In this case, it is possible to use a curing agent having, as radiation curing functional groups, two or more, and preferably three or more, acryloyl or methacryloyl groups per molecule. Examples thereof include TMP (trimethylolpropane) triacrylate, pentaerythritol tetraacrylate, and a urethane acrylate oligomer. In this case, it is preferable to introduce a (meth)acryloyl group not only into the curing agent but also into the binder. In the case of curing with ultraviolet rays, a photosensitizer is additionally used.

It is preferable to add 0 to 80 parts by weight of the curing agent relative to 100 parts by weight of the binder. It is preferable if the amount is in this range since the dispersibility is good.

The amount of binder added to the magnetic layer is preferably 5 to 30 parts by weight relative to 100 parts by weight of the ferromagnetic powder, and more preferably 10 to 20 parts by weight.

Additives may be added as necessary to the magnetic layer of the present invention. Examples of the additives include an abrasive, a lubricant, a dispersant/dispersion adjuvant, a fungicide, an antistatic agent, an antioxidant, a solvent, and carbon black.

Examples of these additives include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; and alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, linolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing).

These dispersants, lubricants, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd); Enujelv OL (produced by New Japan Chemical Co., Ltd.); TA-3 (produced by Shin-Etsu Chemical Industry Co., Ltd.); Armide P (produced by Lion Armour); Duomin TDO (produced by Lion Corporation); BA-41G (produced by The Nisshin Oilli O Group, Ltd.); and Profan 2012E, Newpol PE 61, and Ionet MS-400 (produced by Sanyo Chemical Industries, Ltd.).

In the present invention, an organic solvent used for the magnetic layer can be a known organic solvent. As the organic solvent, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene or cresol, a chlorohydrocarbon such as methylene chloride, ethylene chloride, carbon tetrachloride, chloroform, ethylene chlorohydrin, chlorobenzene, or dichlorobenzene, N,N-dimethylformamide, hexane, tetrahydrofuran, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and a non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

The type and the amount of the dispersant, lubricant, and surfactant used in the magnetic layer in the present invention can be changed as necessary in the magnetic layer and a non-magnetic layer, which will be described later. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, which will be described later, and once adsorbed it is hard to desorb an organophosphorus compound from the surface of a metal, a metal compound, etc. Therefore, since in the present invention the surface of the ferromagnetic powder or the surface of a non-magnetic powder, which will be described later, are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer. Furthermore, all or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

The magnetic layer of the present invention may contain carbon black as necessary. Examples of the carbon black are the same as those used in the radiation-cured layer.

The carbon black may be used singly or in a combination of different types thereof. When the carbon black is used, it is preferably used in an amount of 0.1 to 30 wt % based on the weight of the ferromagnetic powder. The carbon black has the functions of preventing static charging of the magnetic layer, reducing the coefficient of friction, imparting light-shielding properties, and improving the film strength. Such functions vary depending upon the type of carbon black. Accordingly, it is of course possible in the present invention to appropriately choose the type, the amount and the combination of carbon black for the magnetic layer according to the intended purpose on the basis of the above mentioned various properties such as the particle size, the oil absorption, the electrical conductivity, and the pH value, and it is better if they are optimized for the respective layers.

### III. Non-Magnetic Layer

The magnetic recording medium of the present invention can include a non-magnetic layer on a non-magnetic support, the non-magnetic layer containing a binder and a non-magnetic powder. The non-magnetic powder that can be used in the non-magnetic layer may be an inorganic substance or an organic substance. The non-magnetic layer may further include carbon black as necessary together with the non-magnetic powder.

### 1. Non-Magnetic Powder

Details of the non-magnetic layer are now explained.

The magnetic recording medium of the present invention may include a non-magnetic layer (lower layer) including a non-magnetic powder and a binder above a non-magnetic support provided with a radiation-cured layer.

The non-magnetic layer may employ a magnetic powder as long as the lower layer is substantially non-magnetic, but preferably employs a non-magnetic powder.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide.

Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-Iron oxide or a titanium oxide is preferable.

The form of the non-magnetic powder may be any one of acicular, spherical, polyhedral, and tabular.

The crystallite size of the non-magnetic powder is preferably 4 nm to 1 μm, and more preferably 40 to 100 nm. When the crystallite size is in the range of 4 nm to 1 μm, there are no problems with dispersion and a suitable surface roughness is obtained.

The average particle size of these non-magnetic powders is preferably 5 nm to 2 μm, but it is possible to combine non-magnetic powders having different average particle sizes as necessary, or widen the particle size distribution of a single non-magnetic powder, thus producing the same effect. The average particle size of the non-magnetic powder is particularly preferably 10 to 200 nm. It is preferable if it is in the range of 5 nm to 2 μm, since good dispersibility and a suitable surface roughness can be obtained.

The specific surface area of the non-magnetic powder is preferably 1 to 100 m²/g, more preferably 5 to 70 m²/g, and yet more preferably 10 to 65 m²/g. It is preferable if the specific surface area is in the range of 1 to 100 m²/g, since a suitable surface roughness can be obtained, and dispersion can be carried out using a desired amount of binder.

The oil absorption obtained using dibutyl phthalate (DBP) is preferably 5 to 100 mL/100 g, more preferably 10 to 80 mL/100 g, and yet more preferably 20 to 60 mL/100 g.

The specific gravity is preferably 1 to 12, and more preferably 3 to 6. The tap density is preferably 0.05 to 2 g/mL, and more preferably 0.2 to 1.5 g/mL. When the tap density is in the range of 0.05 to 2 g/mL, there is little scattering of particles, the operation is easy, and there tends to be little sticking to equipment.

The pH of the non-magnetic powder is preferably 2 to 11, and particularly preferably 6 to 9. When the pH is in the range of 2 to 11, the coefficient of friction does not increase as a result of high temperature and high humidity or release of a fatty acid.

The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. When the Mohs hardness is in the range of 4 to 10, it is possible to guarantee the durability. The amount of stearic acid absorbed by the non-magnetic powder is preferably 1 to 20 pmol/m², and more preferably 2 to 15 μmol/m².

The heat of wetting of the non-magnetic powder in water at 25° C. is preferably in the range of 20 to 60 μJ/cm² (200 to 600 erg/cm²). It is preferable to use a solvent that gives a heat of wetting in this range.

The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer in the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, and SN-100, MJ-7, and α-iron oxide E270, E271, and E300 (manufactured by Ishihara Sangyo Kaisha Ltd.), titanium oxide STT-4D, STT-30D, STT-30, and STT-65C (manufactured by Titan Kogyo Co., Ltd.), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO2P25 (manufactured by Nippon Aerosil Co., Ltd.), 100A, and 500A (manufactured by Ube Industries, Ltd.), Y-LOP (manufactured by Titan Kogyo Co., LTD.), and calcined products thereof. Particularly preferred non-magnetic powders are titanium dioxide and α-iron oxide.

By mixing carbon black with the non-magnetic powder, the surface electrical resistance of the non-magnetic layer can be reduced, the light transmittance can be decreased, and a desired μVickers hardness can be obtained. The μVickers hardness of the non-magnetic layer is preferably 25 to 60 kg/mm², and is more preferably 30 to 50 kg/mm² in order to adjust the head contact, and can be measured using a thin film hardness meter (HMA-400 manufactured by NEC Corporation) with, as an indentor tip, a triangular pyramidal diamond needle having a tip angle of 80° and a tip radius of 0.1 μm. The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer in the present invention is preferably 100 to 500 m²/g, and more preferably 150 to 400 m²/g, and the DBP oil absorption thereof is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black that can be used in the non-magnetic layer in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo).

The carbon black may be surface treated using a dispersant or grafted with a resin, or part of the surface thereof may be converted into graphite. Prior to adding carbon black to a coating solution, the carbon black may be predispersed with a binder. The carbon black is preferably used in a range that does not exceed 50 wt % of the above-mentioned non-magnetic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Binran (Carbon Black Handbook) (edited by the Carbon Black Association of Japan).

It is also possible to add an organic powder to the non-magnetic layer, depending on the intended purpose. Examples of such an organic powder include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used. Production methods such as those described in JP-A-62-18564 and JP-A-60-255827 may be used.

### IV. Non-Magnetic Support

With regard to the non-magnetic support that can be used in the present invention, known biaxially stretched films such as polyethylene terephthalate, polyethylene naphthalate, polyamide, polyamideimide, and aromatic polyamide can be used. Among these, polyethylene terephthalate, polyethylene naphthalate, and polyamide are preferred.

These supports may be subjected in advance to a corona discharge treatment, a plasma treatment, a treatment for enhancing adhesion, a thermal treatment, etc. The non-magnetic support that can be used in the present invention preferably has a surface roughness such that its center plane average surface roughness Ra is in the range of 3 to 10 nm for a cutoff value of 0.25 mm.

### V. Backcoat Layer

In general, there is a strong requirement for magnetic tapes for recording computer data to have better repetitive transport properties than video tapes and audio tapes. In order to maintain such better repetitive transport properties , a backcoat layer can be provided on the surface of the non-magnetic support opposite to the surface where the non-magnetic layer and the magnetic layer are provided. As a coating solution for the backcoat layer, a binder and a particulate component such as an abrasive or an antistatic agent are dispersed in an organic solvent. As a granular component, various types of inorganic pigment or carbon black may be used. As the binder, a resin such as nitrocellulose, a phenoxy resin, a vinyl chloride resin, or a polyurethane can be used singly or in combination.

### VI. Layer Structure

In the constitution of the magnetic recording medium used in the present invention, the thickness of the radiation-cured layer is preferably in the range of 0.1 to 1.0 μm, as described above, and more preferably 0.3 to 0.7 μm. Furthermore, the thickness of the non-magnetic support is preferably 3 to 80 μm, more preferably 3 to 20 μm, and yet more preferable 3 to 10 μm. Moreover, the thickness of the backcoat layer provided on the surface of the non-magnetic support opposite to the surface where the non-magnetic layer and the magnetic layer are provided is preferably 0.1 to 1.0 μm, and more preferably 0.2 to 0.8 μm.

The thickness of the magnetic layer is optimized according to the saturation magnetization and the head gap of the magnetic head and the bandwidth of the recording signal, but it is preferably 0.01 to 0.12 μm, and more preferably 0.02 to 0.10 μm. The percentage variation in thickness of the magnetic layer is preferably ±50% or less, and more preferably ±40% or less. The magnetic layer can be at least one layer, but it is also possible to provide two or more separate layers having different magnetic properties, and a known configuration for a multilayer magnetic layer can be employed.

The thickness of the non-magnetic layer in the present invention is preferably 0.2 to 3.0 μm, more preferably 0.3 to 2.5 μm, and yet more preferably 0.4 to 2.0 μm. The non-magnetic layer of the magnetic recording medium of the present invention exhibits its effect if it is substantially non-magnetic, but even if it contains a small amount of a magnetic substance as an impurity or intentionally, if the effects of the present invention are exhibited the constitution can be considered to be substantially the same as that of the magnetic recording medium of the present invention. ‘Substantially the same’ referred to here means that the non-magnetic layer has a residual magnetic flux density of 10 T·m (100 G) or less or a coercive force of 7.96 kA/m (100 Oe) or less, and preferably has no residual magnetic flux density and no coercive force.

### VII. Production Method

A process for producing a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages. All materials, including the ferromagnetic hexagonal ferrite powder, the ferromagnetic metal powder, the non-magnetic powder, the binder, the carbon black, the abrasive, the antistatic agent, the lubricant, and the solvent used in the present invention may be added in any step from the beginning or during the course of the step. The addition of each material may be divided across two or more steps. For example, a binder can be divided and added in a kneading step, a dispersing step, and a blending step for adjusting the viscosity after dispersion. To attain the object of the present invention, a conventionally known production technique may be employed as a part of the steps. In the kneading step, it is preferable to use a powerful kneading machine such as an open kneader, a continuous kneader, a pressure kneader, or an extruder. When a kneader is used, all or a part of the binder (preferably 30 wt % or above of the entire binder) and the magnetic powder or the non-magnetic powder are kneaded at 15 to 500 parts by weight relative to 100 parts by weight of the ferromagnetic powder or the non-magnetic powder. Details of these kneading treatments are described in JP-A-1-106338 and JP-A-1-79274. For the dispersion of the magnetic layer solution and a non-magnetic layer solution, glass beads may be used. As such glass beads, a dispersing medium having a high specific gravity such as zirconia beads, titania beads, or steel beads is suitably used. An optimal particle size and packing density of these dispersing media is used. A known disperser can be used.

The process for producing the magnetic recording medium of the present invention includes providing a radiation-cured layer of a predetermined thickness which is a smoothing layer on the surface of a moving non-magnetic support, and coating further above this layer a non-magnetic layer coating solution or a magnetic layer coating solution so as to give a predetermined coating thickness. A plurality of magnetic layer coating solutions can be applied successively or simultaneously in multilayer coating, and a magnetic layer coating solution as the first layer from the smoothing layer and another magnetic layer coating solution as the second layer from the smoothing layer can also be applied successively or simultaneously in multilayer coating. Furthermore, a non-magnetic layer coating solution as the first layer from the smoothing layer, and a magnetic layer coating solution as the second layer from the smoothing layer, can also be applied successively or simultaneously in multilayer coating. As coating equipment for applying the above-mentioned magnetic layer coating solution or the lower non-magnetic layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a fine ferromagnetic metal powder, in general, in-plane two-dimensional random is preferable, but it can be three-dimensional random by introducing a vertical component. In the case of a hexagonal ferrite, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 to 1,000 m/min and the temperature of drying air to be 60° C. or higher, and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to carry out a treatment with metal rolls. The magnetic recording medium of the present invention preferably has a surface center plane average roughness in the range of 0.1 to 4.0 nm for a cutoff value of 0.25 mm, and more preferably 0.5 to 3.0 nm, which is extremely smooth. As a method therefor, a magnetic layer formed by selecting a specific ferromagnetic powder and binder as described above is subjected to the above-mentioned calendering treatment. With regard to calendering conditions, the calender roll temperature is preferably in the range of 60° C. to 100° C., more preferably in the range of 70° C. to 100° C., and particularly preferably in the range of 80° C. to 100° C., and the pressure is preferably in the range of 100 to 500 kg/cm, more preferably in the range of 200 to 450 kg/cm, and particularly preferably in the range of 300 to 400 kg/cm.

As thermal shrinkage reducing means, there is a method in which a web is thermally treated while handling it with low tension, and a method (thermal treatment) involving thermal treatment of a tape when it is in a layered configuration such as in bulk or installed in a cassette, and either can be used. In the former method, the effect of the imprint of projections of the surface of the backcoat layer is small, but the thermal shrinkage cannot be greatly reduced. On the other hand, the latter thermal treatment can improve the thermal shrinkage greatly, but when the effect of the imprint of projections of the surface of the backcoat layer is strong, the surface of the magnetic layer is roughened, and this causes the output to decrease and the noise to increase. In particular, a high output and low noise magnetic recording medium can be provided for the magnetic recording medium accompanying the thermal treatment. The magnetic recording medium thus obtained can be cut to a desired size using a cutter, a stamper, etc. before use.

### VIII. Physical Properties

The saturation magnetic flux density of the magnetic layer of the magnetic recording medium used in the present invention is preferably 100 to 300 mT (1,000 to 3,000 G). The coercive force (Hc) of the magnetic layer is preferably 143.3 to 318.4 kA/m (1,800 to 4,000 Oe), and more preferably 159.2 to 278.6 kA/m (2,000 to 3,500 Oe). It is preferable for the coercive force distribution to be narrow, and the SFD and SFDr are preferably 0.6 or less, and more preferably 0.2 or less.

The coefficient of friction, with respect to a head, of the magnetic recording medium used in the present invention is preferably 0.5 or less at a temperature of −10° C. to 40° C. and a humidity of 0% to 95%, and more preferably 0.3 or less. The electrostatic potential is preferably −500 V to +500 V. The modulus of elasticity of the magnetic layer at an elongation of 0.5% is preferably 0.98 to 19.6 GPa (100 to 2,000 kg/mm²) in each direction within the plane, and the breaking strength is preferably 98 to 686 MPa (10 to 70 kg/mm²); the modulus of elasticity of the magnetic recording medium is preferably 0.98 to 14.7 GPa (100 to 1,500 kg/mm²) in each direction within the plane, the residual elongation is preferably 0.5% or less, and the thermal shrinkage at any temperature up to and including 100° C. is preferably 1% or less, more preferably 0.5% or less, and most preferably 0.1% or less.

The glass transition temperature of the magnetic layer (the maximum point of the loss modulus in a dynamic viscoelasticity measurement at 110 Hz) is preferably 50° C. to 180° C., and that of the non-magnetic layer is preferably 0° C. to 180° C. The loss modulus is preferably in the range of 1×10⁷ to 8×10⁸ Pa (1×10⁸ to 8×10⁹ dyne/cm²), and the loss tangent is preferably 0.2 or less. It is preferable if the loss tangent is 0.2 or less, since the problem of tackiness hardly occurs. These thermal properties and mechanical properties are preferably substantially identical to within 10% in each direction in the plane of the medium.

Residual solvent in the magnetic layer is preferably 100 mg/m² or less, and more preferably 10 mg/m² or less. The porosity of the coating layer is preferably 30 vol % or less for both the non-magnetic layer and the magnetic layer, and more preferably 20 vol % or less. In order to achieve a high output, the porosity is preferably small, but there are cases in which a certain value should be maintained depending on the intended purpose. For example, in the case of disk media where repetitive use is considered to be important, a large porosity is often preferable from the point of view of storage stability.

The center plane surface roughness Ra of the magnetic layer is preferably 4.0 nm or less, more preferably 3.0 nm or less, and yet more preferably 2.0 nm or less, when measured using a TOPO-3D with the Mirau method. The maximum height SRmax of the magnetic layer is preferably 0.5 μm or less, the ten-point average roughness SRz is 0.3 μm or less, the center plane peak height SRp is 0.3 μm or less, the center plane valley depth SRv is 0.3 μm or less, the center plane area factor SSr is 20% to 80%, and the average wavelength Sλa is 5 to 300 μm. It is possible to set the number of surface projections on the magnetic layer having a size of 0.01 to 1 μm at any level in the range of 0 to 2,000 projections per 100 μm², and by so doing the electromagnetic conversion characteristics and the coefficient of friction can be optimized, which is preferable. They can be controlled easily by controlling the surface properties of the support by means of a filler, the particle size and the amount of a powder added to the magnetic layer, and the shape of the roll surface in the calendering process. The curl is preferably within ±3 mm.

When the magnetic recording medium of the present invention has a non-magnetic layer and a magnetic layer, it can easily be anticipated that the physical properties of the non-magnetic layer and the magnetic layer can be varied according to the intended purpose. For example, the elastic modulus of the magnetic layer can be made high, thereby improving the storage stability, and at the same time the elastic modulus of the non-magnetic layer can be made lower than that of the magnetic layer, thereby improving the head contact of the magnetic recording medium.

A head used for playback of signals recorded magnetically on the magnetic recording medium of the present invention is not particularly limited, but an MR head is preferably used. When an MR head is used for playback of the magnetic recording medium of the present invention, the MR head is not particularly limited and, for example, a GMR head or a TMR head may be used. A head used for magnetic recording is not particularly limited, but it is preferable for the saturation magnetization to be 1.0 T or more, and more preferably 1.5 T or more.

The coefficient of thermal expansion of the magnetic recording medium of the present invention is preferably no greater than 14.0 ppm/° C., more preferably no greater than 13.0 ppm/° C., and yet more preferably no greater than 12.5 ppm/° C. When the coefficient of thermal expansion is in the above-mentioned range, the magnetic recording medium has excellent storage stability.

The coefficient of thermal expansion may be obtained by setting a sample of 30 mm in the width direction by 5 mm in the longitudinal direction cut from a tape in TMA equipment, aging it at 30° C. and 30% RH for 24 hours, then measuring a change in the TD direction dimension in going from a temperature of 30° C. to a temperature of 40° C., and determining the coefficient of thermal expansion using the equation below.

Coefficient of thermal expansion=((length of medium at 40° C.−length of medium at 30° C.)/length of medium at 30° C.)/temperature change (40° C.−30° C.)

The TD direction referred to here means the width direction of the magnetic recording medium.

The coefficient of thermal expansion is expressed in units of ppm/° C.

In accordance with the present invention, there can be provided a magnetic recording medium having improved coating smoothness, electromagnetic conversion characteristics, and transport durability. Furthermore, there can be provided a magnetic recording medium that can suppress thermal expansion and has improved storage stability.

### EXAMPLES

The present invention is explained more specifically below by reference to Examples, but the present invention should not be construed as being limited thereby. ‘Parts’ in the Examples means ‘parts by weight’ unless otherwise specified.

### Example 1

Treatment of Inorganic Powder with Silane Coupling Agent

A colloidal silica having an average primary particle size of 12 nm (methanol dispersion) (PL1-MA, manufactured by Fuso Chemical Co., Ltd.) was heated at 80° C., butanol was added dropwise thereto while evaporating methanol to thus carry out solvent replacement, and a butanol-dispersed sol was obtained.

Subsequently, acetic acid was added at 20 wt % relative to the butanol sol, hexyltrimethoxysilane was added at 20 wt % relative to the colloidal silica (solids content), and the mixture was stirred at 80° C. for 2 hours, thus carrying out a surface treatment.

Subsequently, the temperature was raised to 140° C., cyclohexanone was added dropwise while evaporating butanol to thus carry out solvent replacement, and a cyclohexanone sol was obtained.

### Preparation of Coating Solution for Radiation-Cured Layer

The radiation curing compound and the cyclohexanone sol (solids content 15 wt %) at the composition shown in Table 1 were diluted with cyclohexanone so as to give a solids concentration of 20 wt %, stirred for 20 minutes, and filtered using a filter having an average pore size of 0.1 μm, thus preparing a coating solution for the radiation-cured layer.

### Preparation of Magnetic Coating Solution

100 parts of ferromagnetic alloy powder (composition: Co 20%, Al 9%, and Y 6% relative to 100 atom % Fe; Hc 175 kA/m; crystallite size 11 nm; BET specific surface area 70 m²/g; major axis length 45 nm; σs 111 emu/g) was ground in an open kneader for 10 minutes, and then kneaded for 60 minutes with 15 parts (solids content) of a polyurethane resin solution (polyester polyurethane containing 70 μeq/g of SO₃Na groups, Tg=100° C., Mw=70,000), following this, 2 parts of abrasive (Al₂O₃, particle size 0.3 μm), 2 parts of carbon black (particle size 40 nm), and 200 parts of methyl ethyl ketone/toluene=1/1 were added, and the mixture was dispersed in a sand mill for 360 minutes.

To this 2 parts of butyl stearate, 1 part of stearic acid, and 50 parts of cyclohexanone were added and after stirring the mixture for a further 20 minutes, it was filtered using a filter having an average pore size of 1 μm to give a magnetic coating solution.

### Preparation of Non-Magnetic Coating Solution

85 parts of α-Fe₂O₃ (average particle size 0.15 μm; SBET 52 m²/g; surface treatment with Al₂O₃ and SiO₂; pH 6.5 to 8.0) was ground in an open kneader for 10 minutes, and then kneaded for 60 minutes with a compound obtained by adding 7.5 parts of sodium hydroxyethylsulfonate to a copolymer of vinyl chloride/vinyl acetate/glycidyl methacrylate=86/9/5 (SO₃Na=6×10⁻⁵ eq/g, epoxy=10⁻³ eq/g, Mw=30,000), 10 parts (solids content) of a polyurethane resin solution (polyester polyurethane containing 70 μeq/g of SO₃Na groups, Tg=100° C., Mw=70,000), and 60 parts of cyclohexanone, subsequently, 200 parts of methyl ethyl ketone/cyclohexanone=6/4 was added, and the mixture was dispersed in a sand mill for 120 minutes. To this were added

| | |
|---|---|
| butyl stearate | 2 parts |
| stearic acid | 1 part, and |
| methyl ethyl ketone | 50 parts, |

and after stirring the mixture for a further 20 minutes, it was filtered using a filter having an average pore size of 1 μm to give a non-magnetic coating solution (a coating solution for non magnetic layer).

The surface of a 7 μm thick polyethylene terephthalate support having a center average surface roughness Ra of 3.1 nm was coated by means of a wire-wound bar with the above mixture so that the dry thickness would be 0.5 μm. After drying, the coated surface was cured by irradiation with an electron beam at an acceleration voltage of 120 kV so as to give an absorbed dose of 20 kGy.

Subsequently, using reverse roll simultaneous multilayer coating, the non-magnetic coating solution was applied on top of the radiation-cured layer and the magnetic coating solution was applied on top of the non-magnetic coating solution so that the dry thicknesses would be 1.5 μm and 0.1 μm respectively. Before the magnetic coating solution had dried, it was subjected to magnetic field alignment using a 5,000 G Co magnet and a 4,000 G solenoid magnet, the solvent was dried off, and the coating was then subjected to a calender treatment employing a metal roll-metal roll-metal roll-metal roll-metal roll-metal roll-metal roll combination (speed 100 m/min, line pressure 300 kg/cm, temperature 90° C.) and then slit to a width of ½ inch.

### Examples 2 to 17 and Comparative Examples 1 to 5

The procedure of Example 1 was repeated except that the radiation curing compound and the inorganic powder were changed as shown in Table 1.

The content of the inorganic powder that has been surface treated with a silane coupling agent is the content (vol %) in the radiation-cured layer after curing.

TABLE 1

| | | Inorganic powder | | | | | Electromagnetic | Coefficient | |
|---|---|---|---|---|---|---|---|---|---|
| | Radiation | | | Average | | Smoothness | conversion | of thermal | |
| | curing | | Surface | particle | Powder | Ra | characteristics | expansion | Edge damage |
| | compound | Type | treatment | size | content | (nm) | (dB) | (ppm/° C.) | on sliding |
| Ex. 1 | DCPA | Silica | Hex-TMS | 12 nm | 40 vol % | 1.7 | 1.4 | 11.7 | Excellent |
| Ex. 2 | DCPA | Silica | De-TMS | 12 nm | 40 vol % | 1.6 | 1.7 | 11.8 | Excellent |
| Ex. 3 | DCPA | Silica | S-TMS | 12 nm | 40 vol % | 1.4 | 1.6 | 11.6 | Excellent |
| Ex. 4 | HDA | Silica | Hex-TMS | 12 nm | 40 vol % | 1.6 | 1.7 | 11.6 | Excellent |
| Ex. 5 | TMPA | Silica | Hex-TMS | 12 nm | 40 vol % | 1.8 | 1.7 | 11.5 | Excellent |
| Ex. 6 | HDA | Silica | Ph-TMS | 12 nm | 40 vol % | 1.6 | 1.6 | 11.7 | Excellent |
| Ex. 7 | HDA | Silica | Acr-TMS | 12 nm | 40 vol % | 1.7 | 1.7 | 11.6 | Excellent |
| Ex. 8 | HDA | Silica | Hex-TES | 12 nm | 40 vol % | 1.5 | 1.6 | 11.6 | Excellent |
| Ex. 9 | HDA | Silica | Hex-TPS | 12 nm | 40 vol % | 1.5 | 1.4 | 11.6 | Excellent |
| Ex. 10 | HDA | Silica | Hex-TMS | 12 nm | 40 vol % | 1.6 | 1.5 | 11.7 | Excellent |
| Ex. 11 | DCPA | Silica | Hex-TMS | 5 nm | 40 vol % | 1.4 | 1.8 | 12.1 | Excellent |
| Ex. 12 | DCPA | Silica | Hex-TMS | 50 nm | 40 vol % | 2.1 | 0.7 | 12.2 | Excellent |
| Ex. 13 | DCPA | α-Iron | Hex-TMS | 50 nm | 40 vol % | 2.2 | 0.6 | 12.3 | Excellent |
| | | oxide | | | | | | | |
| Ex. 14 | DCPA | Titanium | Hex-TMS | 50 nm | 40 vol % | 2.1 | 0.7 | 11.8 | Excellent |
| | | dioxide | | | | | | | |
| Ex. 15 | DCPA | Silica | Hex-TMS | 12 nm | 30 vol % | 1.4 | 1.2 | 12.1 | Excellent |
| Ex. 16 | DCPA | Silica | Hex-TMS | 12 nm | 60 vol % | 2 | 0.7 | 10.7 | Excellent |
| Ex. 17 | DCPA | Silica | Hex-TMS | 60 nm | 40 vol % | 2.6 | 0.3 | 12.2 | Good |
| Comp. | DCPA | — | — | — | — | 1.6 | 0 | 14.5 | Poor |
| Ex. 1 | | | | | | | | | |
| Comp. | HDA | — | — | — | — | 1.4 | 0.1 | 14.6 | Poor |
| Ex. 2 | | | | | | | | | |
| Comp. | TMPA | — | — | — | — | 1.6 | −0.2 | 14.1 | Poor |
| Ex. 3 | | | | | | | | | |
| Comp. | — | Silica | Hex-TMS | 12 nm | 100 vol % | Coating could not be formed. | | | |
| Ex. 4 | | | | | | | | | |
| Comp. | DCPA | Silica | — | — | 40 vol % | 3.6 | −1.2 | 11.2 | Good |
| Ex. 5 | | | | | | | | | |

The surface treatment agents and the radiation curing compounds shown in Table 1 are as follows.

### Radiation Curing Compounds

DCPA: tricyclodecanedimethanol diacrylate
HDA: hexanediol diacrylate
TMPA: trimethylolpropane triacrylate

### Surface Treatment of Inorganic Powder

Hex-TMS: hexyltrimethoxysilane
De-TMS: decyltrimethoxysilane
S-TMS: stearyltrimethoxysilane
Ph-TMS: phenyltrimethoxysilane
Acr-TMS: acryloxytrimethoxysilane
Hex-TES: hexyltriethoxysilane
Hex-TPS: hexyltripropoxysilane

The average particle size of the inorganic powder that had been surface treated with a silane coupling agent was measured for the silica sol state after the surface treatment with the silane coupling agent, using a fiber-optics particle analyzer (FPAR-1000, manufactured by Otsuka Electronics Co., Ltd.).

Furthermore, the content of the inorganic powder that had been surface treated with a silane coupling agent (treated inorganic powder) in the radiation-cured layer was measured by image analysis by cutting a cross section of the magnetic recording medium so obtained using FIB and then examining the radiation-cured layer by SEM at 50,000 times.

### Measurement Methods

The magnetic recording media produced in Examples 1 to 17 and Comparative Examples 1 to 5 were evaluated as follows.

### (1) Smoothness

The surface of the magnetic layer was examined by an optical interference method using a digital optical profiler and a center average roughness for a 250 μm×250 μm area at a cutoff value of 0.25 mm was defined as Ra.

### (2) Electromagnetic Conversion Characteristics

Measurement was carried out by mounting a prepared magnetic recording medium on a drum tester equipped with a recording head (MIG gap 0.15 μm, 1.8 T) and an MR playback head.

The playback output was measured at a speed of the medium relative to the head of 1 to 3 m/min and a surface recording density of 0.57 Gbit/(inch)² and expressed as a relative value where the playback output of Comparative Example 1 was 0 dB.

### (3) Coefficient of Thermal Expansion

A sample of 30 mm in the width direction by 5 mm in the longitudinal direction was cut out from a tape, set in TMA equipment, and aged at 30° C. and 30% RH for 24 hours. After the ageing, a change in the TD direction dimension from when the temperature was 30° C. to when it was 40° C. was measured, and the coefficient of thermal expansion was determined from the equation below.

Coefficient of thermal expansion=((length of medium at 40° C.−length of medium at 30° C.)/length of medium at 30° C.)/temperature change (40° C.−30° C.)

The TD direction referred to here means the width direction of the magnetic recording medium.

The coefficient of thermal expansion is expressed in units of ppm/° C.

### (4) Edge Damage on Sliding

The tape was made to slide repeatedly at a sliding speed of 2 m/sec for 10,000 passes under an environment of 40° C. and 10% RH with the magnetic layer surface in contact with an AlTiC cylindrical rod at a load of 100 g (T1), and the tape edge was then examined by optical microscope and evaluated using the criteria below.
Excellent: no edge damage.
Good: edge damage present, but radiation-cured layer did not come off.
Poor: radiation-cured layer came off.

What is claimed is:

1. A magnetic recording medium comprising:
a non-magnetic support and, in order thereabove;
a radiation-cured layer cured by exposing a layer comprising a radiation curing compound to radiation; and
a magnetic layer comprising a ferromagnetic powder dispersed in a binder,
the radiation-cured layer comprising an inorganic powder that has been surface treated with a silane coupling agent.

2. The magnetic recording medium according to claim 1, wherein the silane coupling agent is represented by formula (1),
X₄₋ₙ—Si—(Y)ₙ (1)
here, X denotes an alkyl group having 4 to 18 carbons, a phenyl group, a (meth)acryloxy group, or a (meth)acryloxyalkyl group having an alkyl group having 1 to 18 carbons, Y denotes OCH₃, OC₂H₅, or OC₃H₇, and n is 2 or 3.

3. The magnetic recording medium according to claim 1, wherein the silane coupling agent is at least one compound selected from the group consisting of hexyltrimethoxysilane, decyltrimethoxysilane, stearyltrimethoxysilane, phenyltrimethoxysilane, acryloxytrimethoxysilane, hexyltriethoxysilane, and hexyltripropoxysilane.

4. The magnetic recording medium according to claim 1, wherein the inorganic powder that has been surface treated with a silane coupling agent is an organic solvent-dispersed silica sol.

5. The magnetic recording medium according to claim 1, wherein the content in the radiation-cured layer of the inorganic powder that has been surface treated with a silane coupling agent is at least 30 vol % but no greater than 60 vol %.

6. The magnetic recording medium according to claim 1, wherein the inorganic powder that has been surface treated with a silane coupling agent has an average particle size of at least 5 nm but no greater than 50 nm.

7. The magnetic recording medium according to claim 1, wherein the magnetic recording medium comprises, between the radiation-cured layer and the magnetic layer, a non-magnetic layer comprising a non-magnetic powder dispersed in a binder.

8. The magnetic recording medium according to claim 1, wherein the radiation curing compound is an ethylenically unsaturated compound.

9. The magnetic recording medium according to claim 1, wherein the radiation curing compound is a polyfunctional (meth)acrylate compound.

10. The magnetic recording medium according to claim 1, wherein the radiation curing compound is at least one compound selected from the group consisting of tricyclodecanedimethanol diacrylate, hexanediol diacrylate, and trimethylolpropane triacrylate.

11. The magnetic recording medium according to claim 1, wherein it has a coefficient of thermal expansion of no greater than 14.0 ppm/° C.

12. The magnetic recording medium according to claim 1, wherein the non-magnetic support is a non-magnetic support selected from the group consisting of polyethylene terephthalate, polyethylene naphthalate, and polyamide.
